(19) United States
(12) Patent Application Publication
(10) Pub. No.: US 2008/0047903 A1
(43) Pub. Date: Feb. 28, 2008

(54) CONTROL SYSTEM AND PROCESS FOR WASTEWATER TREATMENT

(76) Inventor: Dwain E. Morse, Santa Barbara, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/842,405

(22) Filed: Aug. 21, 2007

Related U.S. Application Data
(60) Provisional application No. 60/823,416, filed on Aug. 24, 2006.

(51) Int. Cl. C02F 9/00; C02F 9/02; C02F 9/04; C02F 9/08

(52) U.S. Cl. 210/704; 210/703; 210/745; 210/749; 210/752; 210/85; 210/96.1

(57) ABSTRACT

A system and process is provided for optimizing chemical additions, mixing energy, mixing time, and other variables while treating a contaminated liquid stream. Samples from the contaminated liquid stream are tested to determine the optimal parameter for each variable, including type and amount of the chemicals to be added, chemical sequence, mixing energy, mixing time, temperature, and pressurization. A system of mixers, a flotation chamber, and a dewatering subsystem are designed to achieve optimal turbidity of the wastewater stream. The system can be modified in real-time in response to a continually changing contaminated liquid stream via a controller and set of sensors, valves, and ports.

### BACKGROUND OF THE INVENTION

The present invention generally relates to wastewater treatment. More particularly, the present invention relates to a control system and process for wastewater treatment, including a control system that monitors and adjusts mixture time, mixing energy, and the quantity of chemicals in the wastewater to optimize waste removal of a constantly changing liquid stream via a unique flotation system.

Industrial wastewater treatment presents many challenges to current technologies. Contaminants are often present in the form of suspended solids. Such solids range in size from macroscopic (inches to hundreds of microns) to colloidal (sub-micron) or even nanoscopic particles. Immiscible oils and other oil loving substances (termed hydrophobic) are also sometimes present and emulsified (solubilized) with the addition of appropriate emulsifying agents—surfactants (detergents) or surface active polymers. It is imperative to remove such contaminants with a cost-effective, reliable process.

Numerous technologies have been developed to achieve efficient solid/liquid separation in industrial wastewater treatment facilities. Historically, gravimetric separations were most commonly used. Sedimentation in large clarifier tanks is used to separate particles with densities greater than water. In addition to gravimetric preparation systems, fine mesh screens or membranes are used to separate the suspended solids as small as 50 microns, for particles not attracted to the screens. But, screens may plug and impede the continual flow of the wastewater as solids are trapped by the screen.

Alternatively, dissolved air flotation (DAF) systems are often used to separate particulate material from liquids, such as wastewater. These systems typically employ the principle that bubbles rising through a liquid attach to and carry away particles suspended in the liquid. As bubbles reach the liquid surface, the attached particles coalesce to form a froth of materials collected. Treatment additives are added to the contaminated liquid and form a homogenous mixture therein that enables the dissolved gas to coalesce into bubbles and take a majority of the contaminants to the surface. If the mixture is not homogenous, an unacceptable amount of contaminants remain in the liquid, even after treatment.

Flotation is generally used to float particles having densities close to that of water, such as fats, oils, and grease, or particles with densities that are greater than water, such as dirt, heavy metals and materials. Flotation is a process where one or more specific particle constituents of a slurry (or suspension of finely dispersed particles or droplets) attach to gas bubbles for separation from water or other constituents. The gas/particle aggregates then float to the top of the flotation vessel for separation from the water or other non-floatable constituents.

Most wastewater solid and emulsified components such as soil particles, fats, oils and greases are charged. Wastewater processing treatment chemicals and additives such as coagulants and flocculants are added to neutralize, charge and initiate nucleation and growth of larger colloidal and suspended particles. These particles are commonly referred to as flocs. Flocs range in size from millimeters to centimeters in diameter when coagulation and flocculation processes are optimized. Adding too many chemicals recharges the flocs and results in breakup or permanent destruction thereof (overcharged particles and/or flocs repel each other and tend to stay apart).

Coagulants are chemicals used to neutralize particle charge and can be inorganic salts such as ferric chloride or polymers such as cationic polyamines. Such chemicals are often viscous and require adequate mixing time and mixing energy to be homogeneously mixed with the incoming wastewater stream. Adding excess chemicals to the contaminated water can result in wasting chemicals and/or creating contaminated discharge water. Too much mixing energy can also result in the irreversible breakup of the flocs and inefficient solid/liquid separation.

Flocculants are large, often coiled, molecular weight polymers used to collect the smaller coagulated flocs into large-size stable flocs to facilitate solid/liquid separation. The flocculants should be uncoiled and thoroughly mixed with the incoming coagulated wastewater stream to facilitate efficient solid/liquid separation. Too much mixing energy or mixing time results in a breakup of the flocs. Too little mixing energy results in inadequate mixing or coiling of the polymer strands. If the polymer strands are wound or “globed” together, the polymer can only attach to a minimal amount of waste particles. If mixing is not optimized, an excessive amount of coagulant or flocculant polymer may be introduced into the contaminated liquid. In an attempt to coagulate to the greatest extent possible, valuable and expensive coagulant and polymer chemicals are wasted from such inefficiency. Alternatively, too much mixing energy may cause irreversible breakup of flocs resulting in inefficient solid/liquid separation.

Conventional systems used a vigorous mixing process over a prolonged time period. This method was believed to provide optimal homogenous mixing. But, it was more recently discovered that certain treatment additives are sensitive to the mixing speed or mixing energy. Thus, over mixing or under mixing has deleterious effects on the additives and alter the homogenous mixing efficiency thereof. Mixing time also varies per treatment additive according to the mixing energy used. To effectively use coagulants and flocculants, the mixing time and mixing energy must be matched with pressurization and depressurization energy to create bubbles that are of adequate size to attach to the flocs and thereafter grow larger. The growth of larger bubbles ensures that the floc clusters float out of the water and to the surface thereof to form the top level slurry or froth.

Traditionally, DAF systems select a fraction of the process exit stream and re-saturate the stream with dissolved gas, typically atmospheric air. This fractional stream is discharged into the lower portion of the flotation tank and the dissolved bubbles rise through the liquid and attach to the contaminated particles in the liquid. The probability of attachment is a function of the number of bubbles formed, the bubble sizes, the collision angle, and the presence of hydrophobic attraction of the bubble to the particle.

DAF system processing time and contaminant removal efficiency typically depends on the residence time of the bubbles in the solution and the probability of bubble/particle contact. The residence time, in turn, is affected by bubble size, bubble buoyancy, the depth at which the bubbles are released in the flotation tank, and the amount of turbulence in the liquid. Relatively large system footprints are necessary to allow the bubbles sufficient time to rise from the bottom of the tank and reach the liquid surface. As a result, conventional DAF systems employ relatively large and costly tanks having correspondingly large “footprints”.

The size of such systems increases the time period between control adjustment and effect. For example, water passing by an adjustment point, such as a polymer inlet stream of the DAF, requires at least a half hour and often over an hour to reach the DAF outlet. Thus, there is a substantial delay before the effect of the adjustment at the DAF system inlet can be ascertained at the DAF system outlet. Accordingly, conventional DAF systems lack real-time or even near real-time control. The long response time results in the production of many gallons of out-of-specification waste water when processing produces a treated effluent stream outside operating requirements.

The above-described limitations are especially true under circumstances where the DAF system receives fluid flow from several dissimilar processes. Often these separate flows make up varying fractions of the total flow entering the DAF system. Thus, the character of the composite flow that reaches the DAF system can commonly change from one minute to the next. Unless adjustments are made to the DAF process, usually via adjustments of chemical dosages, mixing time, or mixing energy, the contaminant removal efficiency varies and may easily fall below requirements.

Hence, current technologies do not satisfactorily respond to fast changing wastewater influent. Conventional systems are often inefficient and generally require a long time to properly remove waste using chemical additives. These systems are often extremely large and take up valuable real estate inside manufacturing facilities. Furthermore, time delays create the possibility that contaminated streams are not receiving the proper chemical mixture, mixing time, and mixing energy to efficiently remove waste thereof. Therefore, a need exists for a wastewater treatment system able to make real-time or near real-time adjustments that respond to shifts in the character of the liquid streams to be treated. The large tank size of a typical DAF tank is counter-productive to making these real-time adjustments.

Accordingly, there is a need for a system for creating an optimum amount of coagulants and flocculants in both quantity and ration by measuring and adjusting imported chemicals, pH, mixing time, temperature and energy. These variables are matched with pressurization and depressurization energy to create bubbles of adequate size to attach to the flocs. These bubbles should further grow into larger bubbles after attaching to the flocs to ensure proper removal of the waste from the water. The system should be adapted to change any of the above-mentioned variables as the wastewater stream changes over time. Real-time variable change ensures efficient flotation of the floc clusters out of the water and replacement of much of the entrained water in the floc cluster with air. The present invention fulfills these needs and provides further related advantages.

### SUMMARY OF THE INVENTION

The system and process of the present invention is designed to control the turbidity and amount of water in solid waste. The control system is designed to optimize the chemical additives (coagulation, flocculation and pH), the mixing energy (both time and magnitude), and the duration the contaminated liquid stream is mixed. Properly adjusting these variables in real-time optimizes the cost of chemical usage versus the characteristics of the system discharge water.

The system is initially set up by first taking samples from the operating stream at different times of the day. Bench test analysis procedures are used to rank impact order for each of the above-described variables. A starting setting for all control parameters is established using these samples. The starting settings are designed to homogenously mix the additives into the liquid stream without physically degrading the aggregates. Ideally, the bubbles are organized for effective bubble/particle attachment in a bloom chamber, effectively positioning the resulting floc and accelerating the drainage of water from said flocs.

Based on the performance objectives (cost of chemicals compared to discharge requirements), directives are established to operate, measure, and adjust the variable parameters as needed. The startup system turbidity, or any other parameter that may be translated into the real-time contamination level of the discharged water, is measured at a nucleation chamber exit. A controller is programmed to first change the charge satisfaction chemical additive. If the turbidity reads over target, the quantity or delivery sequence is changed by adding charge satisfaction chemistry to one or more mixing heads. The sequence and program amount are based on the bench test analysis previously performed. The optimum combination of mixing energy and mixing time of exposure to the stream is generated by analyzing the real-time calculations. Ideally, the system will calculate an ideal lowest turbidity having a minimal cost impact. The controller is programmed to repeat this process by varying the next ranking energy variable identified in the bench test analysis of the stream, until all the variables are taken into account.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic diagram of a control system and process for wastewater treatment embodying the present invention;

FIGS. 2A-2C are graphs illustrating turbidity charted against the amount of chemicals, mixing time, and mixing energy, in accordance with the present invention;

FIG. 3 is a diagrammatic view of a plurality of mixers fluidly connected to one another, in accordance with the present invention;

FIG. 4 is a cross-sectional view of a mixer as used in accordance with the present invention;

FIGS. 5A-5C are perspective views of a cyclone chamber and a sleeve as removed from the mixer in FIG. 4;

FIG. 6 is a diagrammatic view of the plurality of mixers and a flotation tank with a controller operably connected thereto, for performing the real-time measurements and adjustments in accordance with the present invention;

FIGS. 7A-7D are diagrammatic views illustrating selective flow through multiple mixers, in accordance with the present invention; and

FIG. 8 is a flow chart illustrating the process of obtaining optimal efficiency and cost of removing wastewater, in accordance with the present invention.

### DETAILED DESCRIPTION OF THE PREFERRED EMBODIMENTS

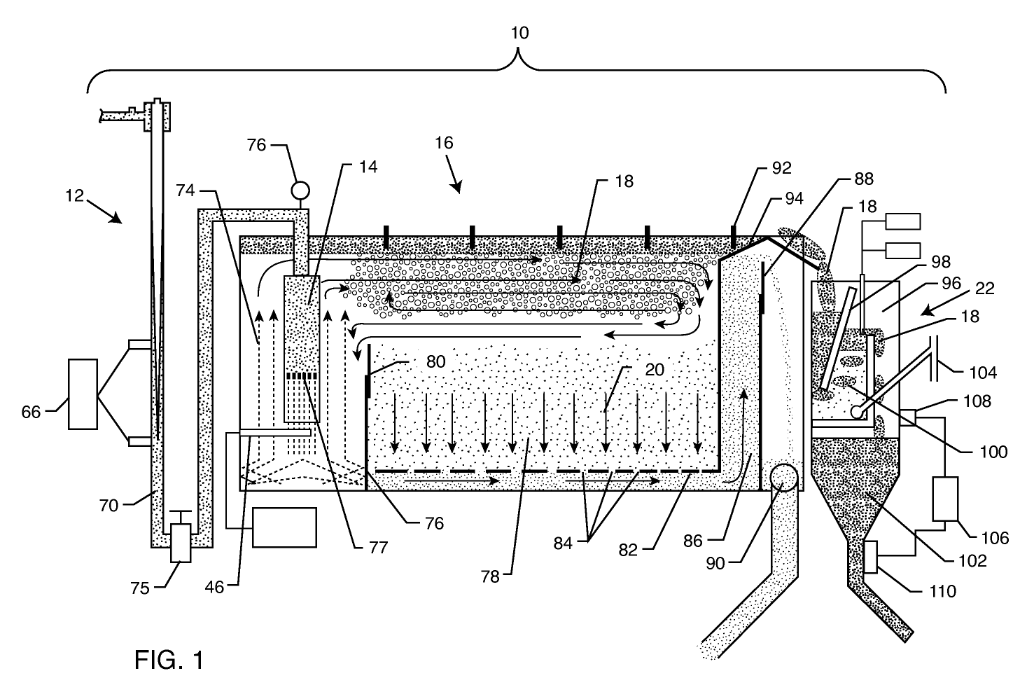

As shown in the exemplary drawings for purposes of illustration, the present disclosure for a wastewater treatment control system and process is referred to generally by the reference numeral 10. Turning now to the representative figures in the specification, FIG. 1 illustrates the wastewater treatment control system 10 having a mixer 12 fluidly coupled to a nucleation chamber 14 which is disposed within a flotation tank 16. The mixer 12, as will be more fully described herein, is particularly designed to mix chemical additives, gas, and the like into the contaminated liquid. The gas is entrained in the liquid at a small size to adhere to solid particles and flocculants. Thereafter, as the liquid passes through the nucleation chamber 14, the bubbles enlarge in size and raise the floc and solid contaminants toward the surface of the flotation tank 16. Eventually, the floated particles form a sludge or froth 18, while the decontaminated liquid 20 sinks to the bottom of the flotation tank 16. The froth 18 is removed to a dewatering subsystem 22 for further dewatering and disposal.

Fluid conditioning in accordance with the present invention is designed to be modulized on any scale. The control system 10 is tuned in real-time to homogonously mix additives into a liquid stream without physically degrading the aggregates. Ideally, the bubbles are organized (according to size, quantity, flotation time, recycle paths) for effective bubble/particle attachment. The control system 10 effectively positions the resulting floc and accelerates the drainage of the decontaminated liquid or water from these flocs. As will be more fully appreciated herein, the present invention dramatically increases the efficiency of removing waste from the stream by monitoring the turbidity and amount of water in the solids by continually regulating and adjusting the amount of chemicals in the liquid, the mixing energy, and the mixing time. In turn, smaller flotation tanks 16 may be used to reduce floor space and material construction costs. As will be more fully explained herein, the adjustable nature of the components in the system allows for real-time process control as process adjustments and measurements are continually made throughout the wastewater treatment control system 10.

The control system 10 is initially calibrated by analyzing a series of samples of contaminated liquid. Typically, a few quarts or a few gallons of the liquid are necessary to accomplish the jar or bench testing. Portions of the liquid are analyzed to determine pH, suspended particle characteristics, etc. The proper chemical additives necessary to alter the pH, coagulate in the particles, and the necessary flocculants to remove the waste from the water are determined from these bench tests.

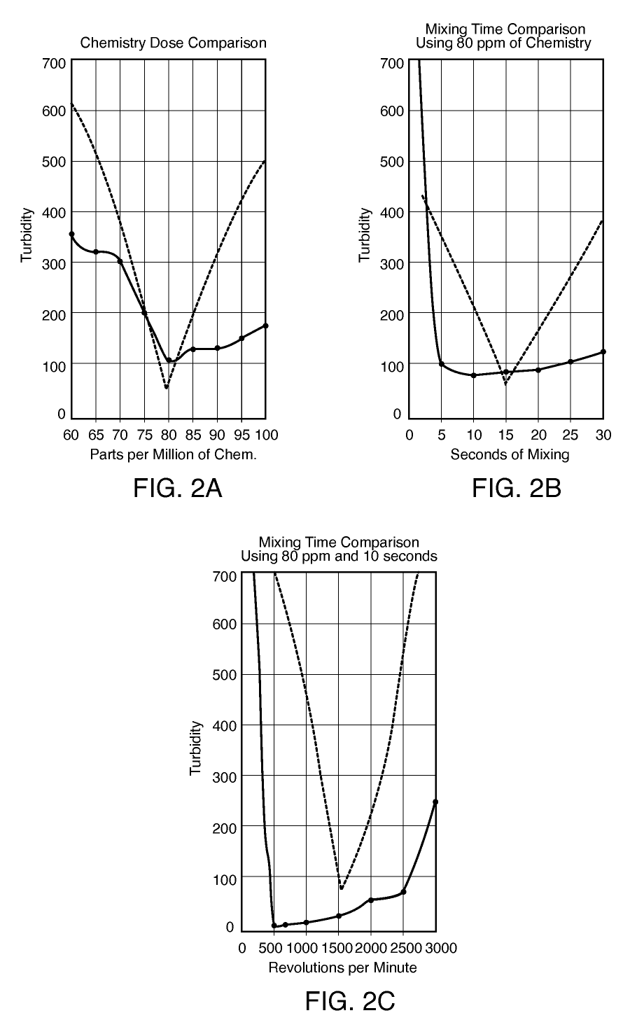

The quality and efficiency of waste removal from a given liquid stream is optimal with lower turbidity. FIGS. 2A-2C illustrate the amount of turbidity against measurable variable quantities of chemicals (FIG. 2A), mixing time (FIG. 2B), and mixing energy (FIG. 2C). The dotted lines in FIGS. 2A-2C represent experimental turbidity test results, while the solid line represents conventional thought regarding the level of turbidity. There is an ideal quantity of chemicals and corresponding duration and speed for mixing that quantity of chemicals in a given contaminated liquid stream, to obtain optimal turbidity. This “sweet spot” for each variable optimizes the reduction of turbidity to yield an efficient removal of waste from the liquid stream. As shown in FIG. 2A, roughly 80 parts per million (ppm) of chemicals obtains the lowest turbidity (sweet spot). Adding fewer than or more than 80 ppm of chemicals yields a higher and less efficient turbidity. Using the optimal chemical quantity of FIG. 2A, the mixing time (FIG. 2B) and mixing energy (FIG. 2C) may be calculated to reduce turbidity. Accordingly, there is an optimal mixing energy (speed or range of speeds) as well as an optimal mixing time (mixing duration) for a given contaminated liquid stream having a specific amount of chemicals therein. From experimentation, it has been found that relatively short mixing times of 10-20 seconds with high mixing energies of 1,000-2,000 revolutions per minute (RPM) in a mechanical mixer yields cleaner water with lower turbidity and larger easier floating flocs. As FIGS. 2B and 2C illustrate, for a chemical composition of 80 ppm, there is an optimal mixing time of 15 seconds and an optimal mixing energy of approximately 1,500 RPM. Variation from these “sweet spots” effectively yields a higher turbidity and lower overall system efficiency. Conventional wisdom of longer mixing times with higher revolution rates actually increases the turbidity of the contaminated liquid. For example, less mixing energy does not fully mix the additives and gas within the contaminated stream to reduce turbidity, while excessive mixing energy can actually destroy the flocculants. Based on the determinations in the jar or bench test, the components of the control system 10 are designed to continually fine-tune chemical quantity, mixing time, and mixing energy in real-time, during the decontamination process.

There are actually many variables that are adjustable to optimize the removal of the contaminants from the liquid stream. The present invention addresses the consideration of each of these and discloses a control system 10 for automatically adjusting these variables over time as the wastewater stream characteristics change. For example, in a manufacturing facility the characteristics of a wastewater stream generated between 9:00 a.m. and 12:00 p.m. may differ from a wastewater stream generated between 12:00 p.m. and 2:00 p.m., when workers may take breaks. The control system 10 of the present invention automatically performs an analysis of the contaminated liquid throughout the entire process. Accordingly, the control system 10 is able to properly adjust the chemicals, mixing time, and mixing energy to optimize the decontamination process.

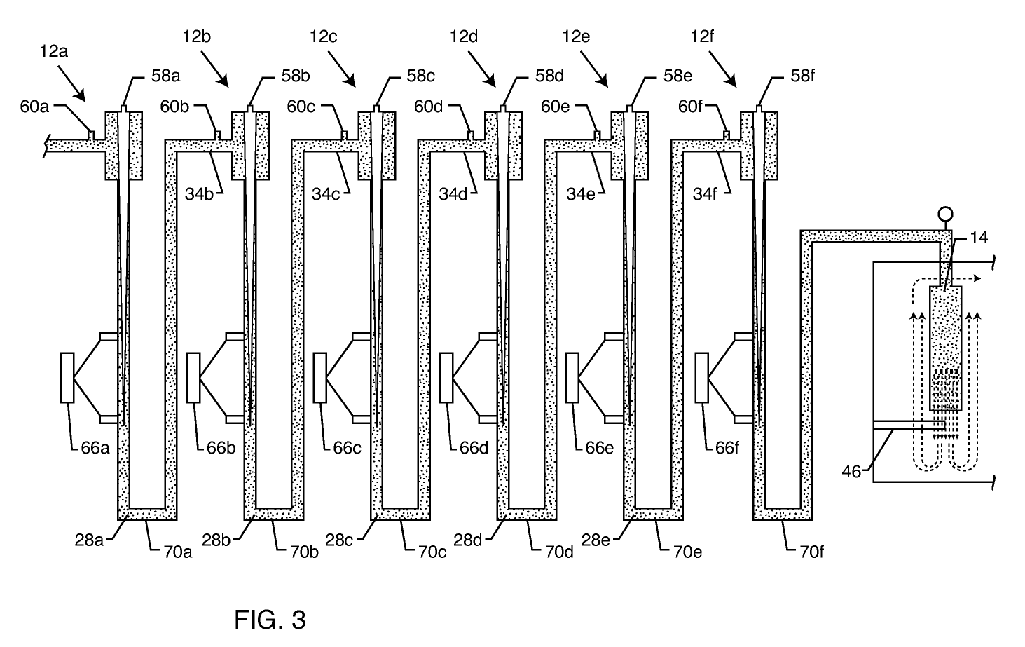

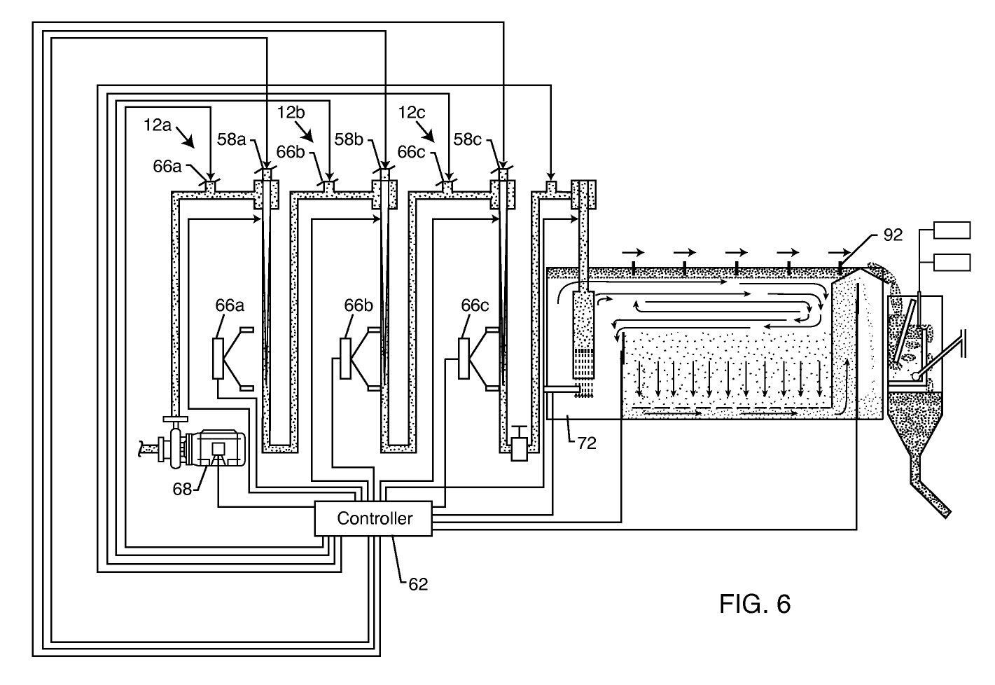

Before entering the control system 10, the contaminated liquid is first screened for objects having dimensions greater than the smallest dimension of any aperture of any component within the wastewater treatment control system 10. These objects are either immediately eliminated from the contaminated liquid or broken down to prevent clogging. The resulting contaminated liquid stream is then pumped at a predetermined pressure into the mixer 12 (FIG. 6). Here, the contaminated liquid stream has the necessary separation enhancement additive chemicals and/or gas added thereto. The mixer 12 (or the plurality of mixers 12a-12f in FIG. 3) regulate the critical variables of chemical quantity, mixing time, and mixing energy of the present invention.

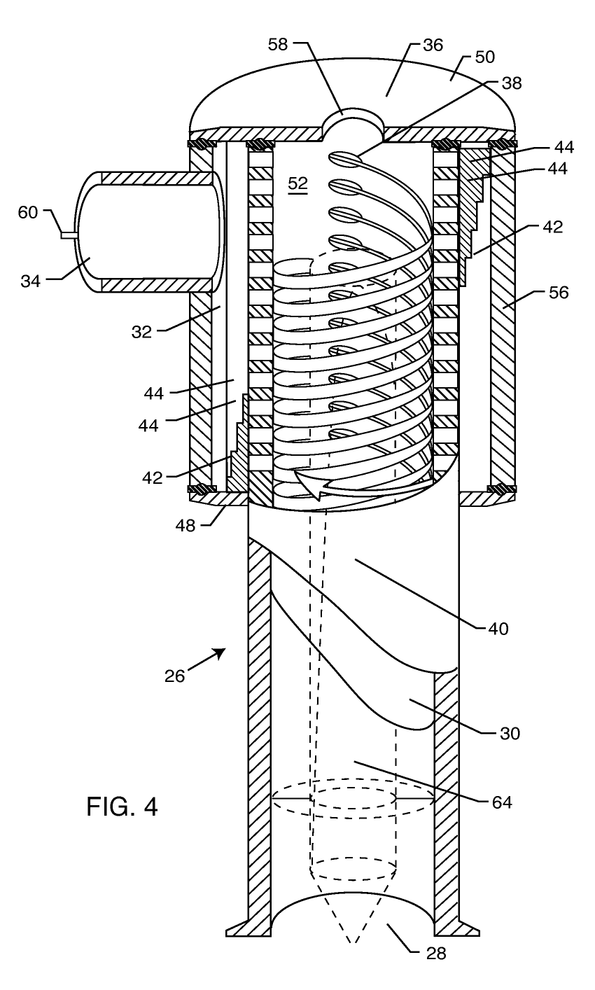

With reference to FIG. 4, the mixer 12 as used in accordance with the present invention is illustrated in detail. This mixer 12 is a hydrocyclone, but unlike a single “hydrocyclone” the mixer 12 has a two-stage delivery mechanism. Similar mixers 12 are disclosed in U.S. Pat. No. 6,964,740 and pending U.S. Publication No. 2004/0178153, the contents of which are hereby incorporated by reference. As shown in FIG. 4, the mixer 12 comprises an upper reactor head 24 and a lower down tube 26 through which the mixed liquid enters and exits via an outlet 28. The mixer 12 is designed such that the reactor head 24 imparts a spinning motion to the contaminated liquid 30 such that a vortex is formed in the down tube 26, causing the additives, liquid, contaminants, and any entrained gas to mix thoroughly and substantially homogonously.

In operation, the mixer 12 delivers liquid into a receiving chamber plenum 32 through a contaminant inlet 34. This plenum 32 spreads the liquid evenly around the exterior of a central cartridge 36 so that the flow of liquid is equalized therearound. The contaminated liquid 30 passes through a series of tangential ports 38 drilled and tapped into the sidewall of the central cartridge 36. The tangential ports 38 direct the liquid into a cyclone spin chamber 40 at a tangent. The central cartridge 36 is configured as any multi-sided block, wherein each facet of the central cartridge 36 has a plurality of tangential ports 38 that provide pathways through which the liquid passes.

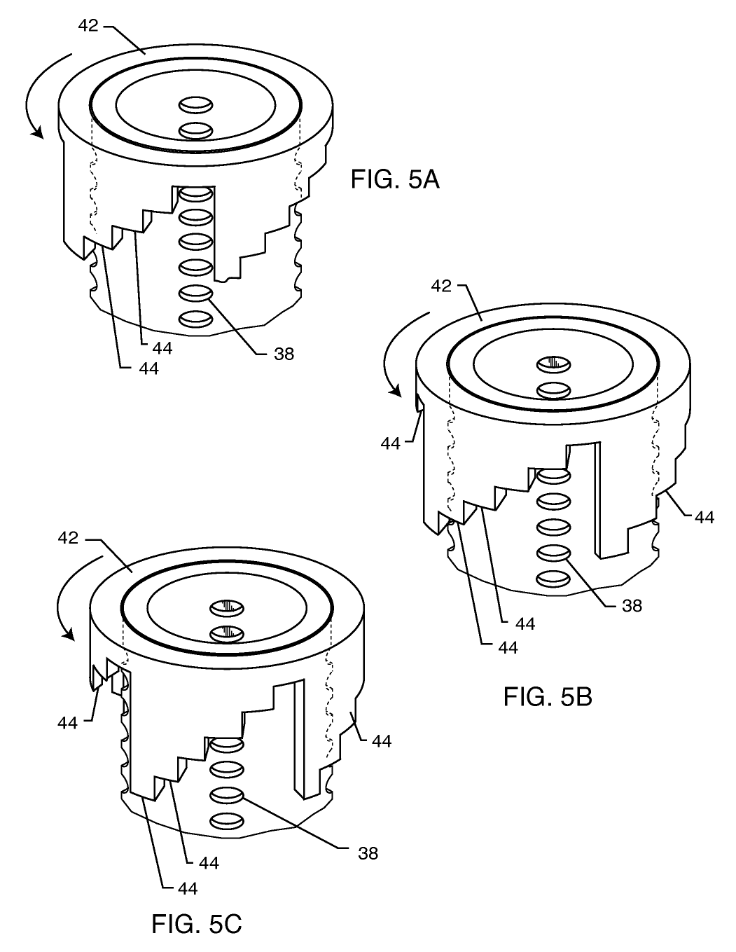

The tangential ports 38 may be opened or restricted by a rotatable regulator sleeve 42 disposed around the exterior perimeter of the central cartridge 36. The regulator sleeve 42 includes a plurality of steps 44 that align with the openings of the tangential ports 38 to regulate the flow of the contaminated liquid 30 through tangential ports 38 of the central cartridge 36. Alignment of the steps 44 with each set of tangential ports 38 can be uniform or staggered (FIGS. 5A-5C) to regulate the number of open tangential ports 38 within the central cartridge 36. The regulator sleeve 42 rotates such that the steps 44 form a watertight seal across the corresponding tangential port 38. The opening or closing of the tangential ports 38 by the regulator sleeve 42 and the steps 44 effectively controls the spinning speed of the contaminated liquid 30 within the cyclone spin chamber 40. As shown in FIG. 5A, none of the tangential ports 38 are covered by the regulator sleeve 42. The mixing energy of the mixer 12 increases with the quantity of open tangential ports 38 capable of transferring the contaminated liquid 30 from the plenum 32 and into the central cartridge 36. By rotating the regulator sleeve 42 counter-clockwise, as shown by the arrows in FIGS. 5A-5C, the tangential ports 38 are gradually covered by the steps 44. Accordingly, decreasing the quantity of open tangential ports 38 decreases the amount of the contaminated liquid 30 flowing therethrough into the central cartridge 36. Thereafter, the spinning speed of the contaminated liquid 30 within the cyclone spin chamber 40 decreases. The spinning speed of the contaminated liquid 30 within the cyclone spin chamber 40 is dependent upon the quantity of the contaminated liquid 30 entering the cyclone spin chamber 40. Increasing the flow rate of the contaminated liquid 30, by opening the quantity of tangential ports 38, increases the mixing energy. Decreasing the flow rate of the contaminated liquid 30, by the decreasing the quantity of open tangential ports 38, effectively decreases the mixing energy. Accordingly, the mixing energy is higher in FIG. 5A relative to the mixing energies in FIG. 5B or 5C.

The regulator sleeve 42 is automatically controlled by an external servo or the like such that the optimal mixing energy may be input into the system to maximize the efficiency for removing waste from the contaminated water 30. The servo may open or close the tangential ports 38 via rotation of the regulator sleeve 42 about the exterior of the central cartridge 36. The servo is capable of rotating the regulator sleeve 42 clockwise or counter-clockwise depending on the current quantity of open tangential ports 38 and the need to either increase or decrease the mixing energy. The servo receives instructions from a central processing unit (CPU) in response to changing turbidity as measured by a turbidity meter 46 disposed within the flotation tank 16, as will be described herein in more detail.

The tangential ports 38 may alternatively be threaded to accommodate fluid flow resistance plugs (not shown), as disclosed in detail in U.S. Pat. No. 6,964,740, the contents of which are herein incorporated by reference. The fluid flow resistance plugs provide an optional alternative embodiment to the regulator sleeve 42. In general, inserting or removing the resistance plugs increases or decreases the energy imparted to the contaminated fluid 30 in the cyclone spin chamber 40 within the mixer 12. The resistance plugs are accessed by removing the central cartridge 36 from within the mixer 12. Any liquid present inside the pressure chamber during adjustment, removal, or addition of the resistance plugs falls back into the cyclone spin chamber 40 when the central cartridge 36 is lifted out. It is preferred in the present invention that the regulator sleeve 42 and corresponding steps 44 be used in lieu of the resistance plugs to better facilitate the real-time adjustments of mixing energy within the mixer 12. The resistance plugs are preferably used as a more permanent solution to either open or close the tangential ports 38.

As shown in FIG. 4, the contaminant inlet 34 of the reactor head 24 is formed in a sidewall of the plenum 32 thereof. A base 48 and a lid 50 seal the enclosure. The central cartridge 36 is disposed within this enclosure of the reactor head 24. The central cartridge 36 is in fluid communication with the down tube 26 as shown. The central cartridge 36 is illustrated in FIG. 4 as being cylindrical. The central cartridge 36 may also be multi-faceted. The central cartridge 36 can be configured as a hexagon, octagon, or any other polygon or multi-faceted structure. The tangential ports 38 are formed in at least one facet thereof, and preferably in every facet thereof. Alignment of the tangential ports 38 along each facet can be uniform or staggered to minimize the ridges in the cyclonic spin chamber 40.

Thus, the contaminated liquid 30 flows into the reactor head 24, through the contaminant inlet 34, and into the plenum 32, defined by the cylindrical space between the central cartridge 36 and an outer housing 56. The contaminated liquid 30 spins into the interior of the central cartridge 36 via the tangential ports 38, as generally shown by the clockwise arrows in FIG. 4. The number of open tangential ports 38, the diameter of the tangential ports 38, the diameter of the central cartridge 36, the diameter of the cyclone spin chamber 40, and the diameter of the down tube 26 determine the rotational speed at which the liquid spins and passes through the outlet 28 of the mixer 12. The real-time adjustments are preferably made via the regulator sleeve 42, which regulates the quantity of open tangential ports 38 as previously described.

The wastewater treatment control system 10 is able to control the quantity of liquid or solid additives injected into the contaminated stream 30. This allows the control system 10 to fine-tune the energy conversion characteristics (conversion of pressure to centrifugal force) and specify the diameter and length of the central gas column in the down tube 26 of the mixer 12. Thus, the control system 10 includes an inlet port 58 for the introduction of gas or other chemicals. Additionally, a secondary inlet port 60 may also introduce either gas or chemicals into the contaminated liquid 30. The quantity of inlet ports may vary depending on the number of gas or chemical additives. It is preferable in the present invention that the additives are added via individual mixers 12, as more fully described herein. When using the mixer 12 as a liquid/solid mixer, the liquids and/or solids are usually added to the stream on the high-pressure side of the mixer 12. The liquids and solids are mixed by accelerating the contaminated liquid 30 via the centrifugal forces acting on the tangential ports 38 and the spinning column of fluid in the down tube 26. Increasing or decreasing the pressure of the contaminated liquid 30 through the inlet 34 changes the mixing energy, similar to opening or closing the tangential ports 38. Accordingly, increasing or decreasing the inlet pressure also helps manage the magnitude of the mixing energy. Sensors, as more fully described herein, measure the characteristics of the contaminated liquid 30 through the down tube 26 to ensure that the control system 10 is achieving the proper mixing energy “sweet spot” to attain optimum flocculation performance. Tuning the mixing energy is a significant, yet overlooked component of conventional DAF flotation system designs.

The diameter of the spinning contaminated liquid 30 within the cyclone spin chamber 40 is regulated by the flow rate of the contaminated liquid 30 into the mixer 12. There are a wide range of flow rates that a given diameter cyclone spin chamber 40 can properly handle. An operating mixer should be replaced by a different mixer when the flow rate of the contaminated liquid 30 exceeds the rating for the cyclone spin chamber diameter of the operating mixer. Accordingly, a larger mixture having larger diameter cyclone spin chamber is required for higher flow rates and a smaller mixer having a smaller cyclone spin chamber is needed for lower flow rates. For example, the cyclone spin chamber 40 with a diameter of one inch can handle a flow rate of between 0.1 and 10 gallons per minute. A two-inch diameter cyclone spin chamber 40 can handle a flow rate between 5 and 80 gallons per minute. A three-inch cyclone spin chamber 40 can handle a flow rate between 70 and 250 gallons per minute. A six-inch diameter cyclone spin chamber 40 can handle a flow rate between 500 and 2,000 gallons per minute. The upper range of these flow rates are not limited by the cyclone spin chamber 40, but by the cost of the pumping system required to deliver the contaminated liquid 30 into the mixer 12, the pressure requirement to process the liquid stream, and the size of the downstream flotation device that processes and separates the resultant liquid/solid components.

It was conventionally thought that longer mixing times (1-10 minutes) at low mixing energies (30-100 RPMs in a mechanical mixer) was needed for optimum flocculation and mixing. But, this is not the case. Shorter mixing times (5-10 seconds) with high mixing energies (up to 4,000 RPM in a mechanical mixer) yielded cleaner water with lower turbidity and larger, easier floating flocs. Thus, the mixing inside the cyclone spin chamber 40 of the mixer 12 may last only a few seconds while yielding excellent flocs without any mechanical premixing or potential polymer breakage. Mixing energy or speed at which the contaminated liquid 30 is passed through the mixer 12 is determined in large part by the quantity of open tangential ports 38 set to receive the contaminated liquid 30, as previously discussed.

There are many energy variables to be considered in the control system 10 of the present invention. Such variables include the type of chemical additives, amount of chemical additive, sequence of chemical additives, amount of mixing energy, sequence of mixing energy, cavitation energy sequence, amount of cavitation energy, fluid flow rate, and average temperature of the fluid stream within each mixer 12. Each of these variables are tested, in view of the bench test analysis procedures as described above, to determine the optimal results for each particular wastewater stream. The wastewater treatment control system 10 of the present invention uses the bench test results in light of continual data analysis during the decontamination process to optimize the sequence of all the aforementioned variables. In particular, the control system 10 closely monitors turbidity via the amount of chemicals added to the contaminated stream and the corresponding mixing time and mixing energy.

The wastewater treatment control system 10 of the present invention can be changed either in automated or manual fashion to alter the above-described variables. For example, bubble nucleation pressures can be delivered between 0.5 to 150 pounds per square inch (psi). Cavitation plates varying in hole size can be inserted at various points within the control system 10 as needed to achieve depressurization. The control system 10 can also optimize, as the stream changes, the amount, frequency of additions, and type of chemical constituents added during the process disclosed herein. Additional variations may include the sequence of chemical additions, rotational energy in mixing, amount of gas delivered and dissolved within the liquid, and the amount of energy left over in the fluid available for downstream bubble nucleation. The process of measuring and adding chemicals and thereafter analyzing such information is used to obtain the highest efficient yield of flocs. Other manipulable variables include pH, redox potential, and temperature. Various bench test procedures are performed throughout the process and programmed into a controller 62 (FIG. 6) such that the control system 10 automatically changes the above-described variables as needed. Furthermore, the overall control system 10 may be programmed to fluctuate throughout the course of a manufacturing period to accommodate the differences in the characteristics and constituents of the wastewater stream.

Additives, such as chemicals, flocculants, coagulants, etc. are typically added to the contaminated stream to alter the chemistry thereof and bind the suspended solids in the contaminated liquid 30. While such additions can occur upstream of the mixer 12, it is preferred in the present invention that such additives are added via either the inlet port 58 or the secondary inlet port 60, as generally shown in FIG. 4. The secondary inlet port 60 may introduce additives immediately before or during mixing. Preferably, the inlet port 58 is formed in the lid 50 of the reactor head 24 such that the gas or other additives introduced therethrough are fed into a central evacuated area 64 such that the spinning liquid absorbs and entrains the gas or other additives introduced into the mixer 12. The central evacuated area 64 forms a vortex of liquid that causes the introduced gas to contact the centrally rotating contaminated liquid 30 while spinning into the lower down tube 26. The gas may be continuously or intermittently added through the inlet port 58 as needed. The size of the central evacuated area 64 affects the amount of the contaminated liquid 30 capable of flowing through the down tube 26. Increasing the size of the central evacuated area 64 accordingly decreases the quantity of the contaminated liquid 30 within the down tube 26. Decreasing the available volume of the contaminated liquid 30 within the down tube 26 effectively increases the spin rate of the contaminated liquid 30 therein. Oppositely, decreasing the size of the central evacuated area 64 increases the volume of the contaminated liquid 30 in the down tube 26. The spinning speed of the contaminated liquid 30 within the down tube 26 therefore decreases. A sensor 66 reads the termination point of the central evacuated area 64 in order to manipulate the physical shape of the vortex by increasing or decreasing the amount of gas added to the mixer 12. Such a sensor 66 may visually, sonically, electronically, or otherwise read or sense location of the vortex to determine the amount of replenishment gas needed to replace the gas absorbed into the contaminated liquid 30 to be carried downstream.

With reference now to FIG. 3, a series of mixers 12a-12f are configured to allow sequential injection of chemicals at optimum mixing energy and mixing time for each chemical constituent individually, if necessary. Multiple gas dissolving vortex exposures may be used to optimize the energy of each gas-mixing vortex. In a preferred embodiment, six mixers 12a-12f, as shown in FIG. 3, are sufficient to saturate the contaminated stream as a result of soft chemical mixing energy. The number, setting, and placement of the mixers 12a-12f is determined and changed according to an analysis taken at the sensors 66a-66f and compared to the data compiled in the original bench tests. The liquid/solid chemicals are added to the stream entrance and the settings of each are fine-tuned for each mixer 12 by measuring the resulting turbidity of the water discharge via the turbidity meter 46 at the nucleation chamber 14 exit. As generally shown in FIG. 6, each of the sensors 66a-66c is electrically coupled to the controller 62. In turn, the controller 62 directly regulates the flow of chemicals and gas via the gas inlet ports 58a-58c and the secondary inlet ports 60a-60c. Depending upon the optimal readings as calculated by the control system 10 via the turbidity meter 46, the flow rate and mixing time may vary in each of the mixers 12a-12c.

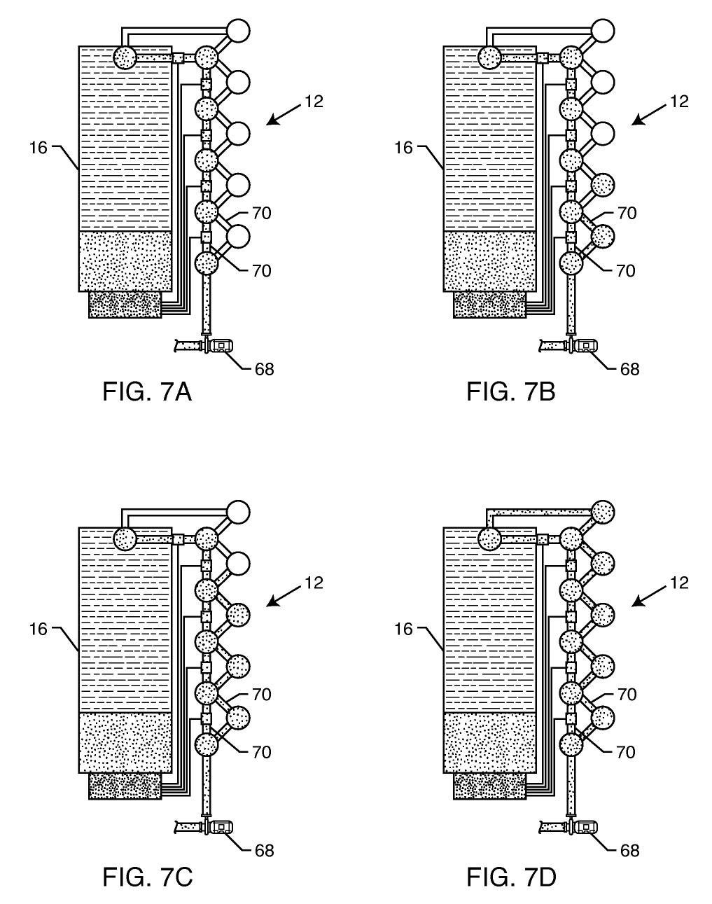

Additionally, the number of mixers 12 may be continually varied within a single system. FIGS. 7A-7D illustrate a top view of a portion of the control system 10 of the present invention. A pump 68 is in fluid communication with a plurality of the mixers 12, which eventually empty into the flotation tank 16. As shown, the mixing time of the contaminated stream, is adjustable by opening or closing valves (not shown) that interconnect each of the mixers 12. For example, the wastewater stream passes through an increasing number of mixers 12 progressing from FIG. 7A to FIG. 7D. FIG. 7A utilizes half of the available mixers 12 while FIG. 7D utilizes all the mixers 12 in the control system 10 shown in FIGS. 7A-7D. Accordingly, FIGS. 7B and 7C utilize an alternative number of mixers 12, as illustrated. Opening valves between the mixers 12 effectively increases the mixing time as it takes longer for the liquid stream to empty into the flotation tank 16. Accordingly, the liquid stream experiences the longest mixing times in FIG. 7D, relative to FIGS. 7A-7C. Oppositely, closing valves between the mixers 12 decreases mixing time. Accordingly, there are fewer mixers 12 to flow through before entering the flotation tank 16. Thus, the mixing time in FIG. 7A is relatively less than the mixing time in FIGS. 7B-7D. The opening and closing of the valves between each of the mixers 12 is regulated by the controller 62. The controller 62 makes real-time adjustments (opening or closing valves) based on continual measurements taken from the turbidity meter 46 and in view of the bench test analysis and optimal turbidity readings.

While multiple mixers 12 are preferred in the present invention, as few as a single mixer 12 is feasible. Again, the number of mixers 12 utilized depends upon the amount of mixing time required to optimize the separation and the quantity and characteristics of the chemical additives. Connecting a plurality of the mixers 12 allows sequential injection of chemicals at optimum mixing energy and mixing time for each individual chemical constituent added during the process. Moreover, multiple gas dissolving vortex exposures provide additional mixing energy. In turn, the control system 10 can optimize the gas-mixing vortex of each additive to sufficiently saturate the stream as a result of soft chemical mixing energy requirements or the like. As will be appreciated by one skilled in the art, a series of tubing 70a-70e (FIG. 3) interconnects the outlets 28a-28e with each corresponding inlet 34b-34f for each mixer 12a-12f. For example, the control system 10 of the present invention enables the addition of high mixing energy into one mixer 12a, which has a relatively large number of tangential ports 38 open to impart a high velocity to the contaminated liquid 30 for forcedly mixing the liquid and the chemical additive therein. Moreover, another mixer 12b may inject a second chemical requiring softer chemical mixing energy than the chemical injected into the previous mixer 12a. This second mixer 12b may have a relatively small number of tangential ports 38 open so as to impart a relatively slow or lower mixing energy. Similarly, instead of utilizing a long down tube 26, the plurality of mixers 12 may be joined in series to prolong the mixing time.

The wastewater treatment control system 10 of the present invention may, in addition to simultaneously delivering liquid or solid additives into the wastewater stream at a controlled rate, modify the diameter or length of the cyclone spin chamber 40 (FIG. 4) in the lower down tube 26 of each mixer 12a-12f. The sensors 66a-66f in FIG. 3 are further able to measure the length of the central evacuated area 64a-64f in each respective mixer 12a-12f. By sensing the central evacuated area 64 termination location, the physical shape of the vortex may be manipulated by increasing or decreasing the amount of gas delivered to the central evacuated area 64, such as through the inlet port 58, as previously described. The sensors 66a-66f may help maintain the vortex position by visually, sonically, electrically, or otherwise reading the location of the central evacuated area 64. As shown in FIG. 6, the sensors 66a-66c send information regarding the characteristics of the central evacuated area 64 to the controller 62, which in turn may increase or decrease the gas flow rate through each respective inlet port 58a-58e to obtain optimal turbidity. Maintaining an optimal vortex includes monitoring the inlet port 58 to ensure the gas is replenished at an adequate rate comparable to the amount of gas absorbed into the liquid and carried downstream to the nucleation chamber 14. The gas may be added in a steady or pulsed manner.

As further shown in FIG. 6, an inline adjustable flow pump 68 controls the liquid flow rate of the liquid stream and can moderate the energy input across the system. The controller 62 can increase the rate of the flow pump 68 to increase energy across the system or, accordingly, decrease the flow rate of the pump 68 to decrease the energy input across the system. The flow may also be adjusted by inserting a flow control valve 71 (FIG. 6) on the high pressure side of the water pump 68. The controller 62 is electronically linked to the various valves, input ports 58, 60, sensors 66, and pump 68 so as to properly adjust the flow rate of gas, liquid, and chemicals into the mixers 12. The controller 62 also dictates the number of mixers 12 through which the liquid wastewater stream is passed and the amount of liquid and gas chemical additives added. The controller 62 is an integral part of the wastewater treatment control system 10 of the present invention for maintaining and stabilizing the optimal mixing time, mixing energy, and quantity of chemicals to obtain the “sweet spot” of FIGS. 2A-2C.

With reference back to FIG. 1, the substantially homogenously mixed stream is directed from the last mixer 12 to the nucleation chamber 14 via the tubing 70. The stream entering the nucleation chamber 14 experiences a pressure drop therein. In a particularly preferred embodiment, the nucleation chamber 14 has a cavitation plate 72 disposed therein. The cavitation plate 72 has a plurality of apertures of a predetermined number and size through which the liquid stream must pass. The design of such apertures in the cavitation plate 72 ensures that the bubbles begin forming at a size small enough to create a long range of hydrophobic forces that promotes bubble/particle attachment. The nucleation chamber 14 of the present invention is designed to create the optimum size and number of bubbles in a continually changing mixing environment.

The nucleation chamber 14 is disposed within a bloom chamber 74 of the flotation tank 16. Here, the contaminated liquid mixture is forced through the cavitation plate 72 and depressurized. Accordingly, the liquid mixture floats to the surface as the nucleated bubbles enlarge in size due to the depressurization and coalescing with other bubbles. The pressure at the cavitation plate 72 is adjustable by changing the impeller size or rotational speed of the pump 68, or by installing a flow control valve 75 to regulate the flow rate and pressure within the tubing 70 leading into the nucleation chamber 14. A pressure gauge 76 that is in electrical communication with the controller 62 is utilized to optimize the flow of the liquid stream into the nucleation chamber 14. The controller 62 receives pressure data from the pressure gage 76. Thereafter, the controller 62 is able to regulate the flow control valve 75 in order to adjust the flow rate of the liquid stream to the nucleation chamber 14. Adjusting the pressure of the liquid stream, as monitored by the pressure gage 76, enables the controller 62 to obtain optimal flocculation within the nucleation chamber 14 and the corresponding bloom chamber 74.

Once the mixed liquid exits the nucleation chamber 14 in the bloom chamber 74, the bubbles begin to enlarge in size and rise toward the upper portion of the flotation tank 16. Not all the bubbles immediately rise to the surface of the liquid within the flotation tank 16. Some of the bubbles take longer to fully enlarge before rising. Coalescing of the bubbles via the cavitation plate 72 speeds up the flotation process. A certain level of residence time is desirable to optimize the flotation of the particles from within the liquid. A wall 77 separates the bloom chamber 74 from a separation chamber 78 of the flotation tank 16. This results in a circulation of bubbles and flocs in the upper portion of the flotation tank 16 as shown by the horizontal directional arrows. The froth 18 consists of the fully floated bubble particles in the flotation tank 16. The froth 18 collects at the surface of the liquid in the flotation tank 16. Continual input of new liquid from the nucleation chamber 14 creates an eddy in the upper portion of the flotation tank 16 wherein the bubbles enlarge and coalesce over time. The wall 77 includes an adjustable weir 80 to control the current flow at the top portion of the flotation tank 16 and also to control the amount of liquid that circulates in the bloom chamber 74. The bloom chamber 74 is constantly recharged with new bubble/liquid from the mixers 12.

The denser decontaminated liquid 20 sinks toward the bottom of the flotation tank 16 as the lighter bubble/particles that form the froth 18 float upwardly toward the surface of the flotation tank 16. In a particularly preferred embodiment, the flotation tank 16 includes a restrictive false bottom 82 having a plurality of flow ports 84 through which the decontaminated liquid 20 sinks. The false bottom 82 balances the flow of decontaminated liquid 20 across the entire bottom of the flotation tank 16 before the decontaminated liquid 20 enters an exit chamber 86. The frequency of the flow ports 84 increases from left to right within the floatation tank 16, as shown in FIG. 1. An adjustable wall 88 is disposed within the exit chamber 86 to control the volume of decontaminated liquid 20 removed from the flotation tank 16 and received through an outlet 90. In this way, the liquid height in the flotation tank 16 is adjustable based on the amount of liquid entering through the nucleation chamber 14 and exiting through the outlet 90. Liquid that exits through the outlet 90 is substantially decontaminated and ready for reuse. In one example, the decontaminated liquid may be used to water a crop.

The buoyant froth 18 at the top surface of the flotation tank 16 is thereafter removed to the dewatering subsystem 22. Typically, a skimmer 92 has a plurality of paddles (generally shown) used to push the froth 18 up a ramp 94 and into a holding chamber 96. The dewatering subsystem 22 uses the excess residual dissolved gas in the water, trapped in the flocs, to coalesce with other nanobubbles trapped in the froth 18 to force out the residual liquid from within the floc froth 18. The skimmer 92 removes the froth 18 at an optimum rate to maintain the height of the liquid within the flotation tank 14, for a particular stream rate. Entrained gas in the froth 16 continually degases via coalescing with other bubbles trapped within the flocs. As a result, these bubbles expand but stay trapped inside the floc. This expansion drives out an equal volume of water from the floc matrix thereby reducing the water content of the froth 18 to provide a dryer, more buoyant froth 18.

The dewatering subsystem 22 includes a holding chamber 96 defined by a sloped wall 98. The holding chamber wall 98 is adjusted to impede the discharge of the froth 18 into a water collection area 100. Floc froth 18 floats on top of the residual liquid until it falls into a removal tank 102. Periodically, the dewatered liquid 103 is removed through an outlet 104 for recirculation back within the control system 10 of the present invention. The pump 68 or other suitable piping, tubing, or pumping system may be directly connected thereto. A paddle wheel or another skimmer may be implemented to force the dewatered floc into the removal tank 102. A froth sensor 106 having an upper level sensor 108 and a lower level sensor 110 is typically connected to a pump such that when the dewatered froth 18 reaches the upper level sensor 108 in the removal tank 102, a pump is activated to remove the froth 18 therefrom for disposal. The pump can be automatically shut off when the lower sensor 110 indicates that the level of froth 18 within the removal tank 102 has reached a relatively low level.

It will be appreciated by those skilled in the art that the control system 10 of the present invention provides many advantages over currently used flotation decontamination systems. The system components have certain structural members and characteristics that control and optimize the creation of bubbles within the flotation tank 16. Moreover, due to the relatively short residence time of the saturated bubbles/liquid in the flotation tank 16, near real-time adjustments are made to modify the flow, pressure, mixing speed, mixing energy and amount of chemicals needed to meet the changing needs of the contaminated stream in real-time. The interaction of the bloom chamber 74 and the separation chamber 78 of the flotation tank 16 enables the flotation tank 16 to have an extremely small footprint (up to ten percent of traditional footprints). Unlike conventional DAF systems, substantially complete and homogenous mixture by the mixer 12 results in a one hundred percent discharge through the nucleation chamber 14 into the flotation tank 16, thus treating the entire contaminated stream flow instead of only a portion of it at a time.

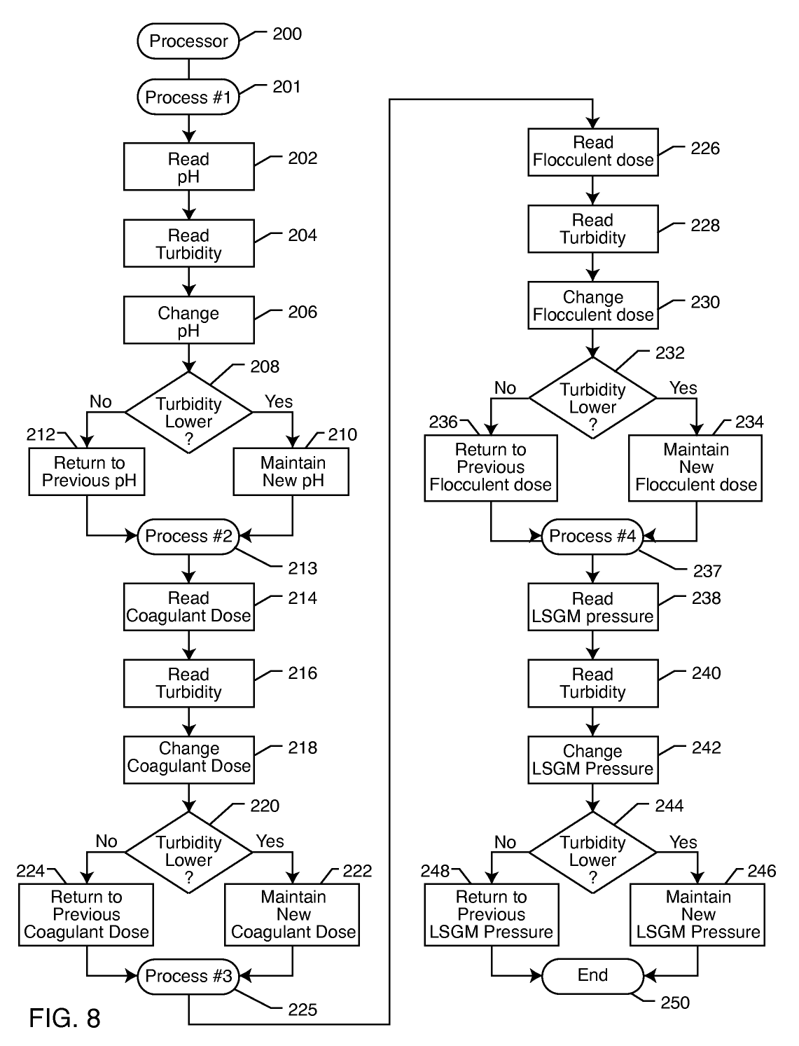

The process for monitoring and regulating the turbidity and ultimately the amount of water in the solid, as adjustable by the mixture time, mixing energy, and amount of chemicals added to the mixture, is detailed in FIG. 8. As previously described, the turbidity meter 46 located within the bloom chamber 74 continually monitors the liquid stream turbidity, including pH level, coagulant dose, and flocculant dose at the nucleation chamber 14 exit. The turbidity meter 46 works in conjunction with the controller 62 to ensure optimal turbidity, pH, coagulant dose, flocculant dose, and LSGM pressure. The controller 62 controls the servos, sensors, valves, ports, and pumps to regulate the pH, coagulate dose, flocculant dose, and pressure to obtain the optimal turbidity for the elimination of water in the froth 18. Accordingly, the aforementioned components of the control system 10 are capable of adjusting the mixture time, mixing energy, and amount of chemicals within the mixture to reduce the amount of water in the solids and obtain the optimal turbidity. A processor, which is integrated into the controller 62 (FIG. 3), receives and computes information regarding pH levels, coagulant dose levels, flocculant dose levels, and the LSGM pressure levels. Accordingly, the sensors, servos, valves, ports, and pumps provide feedback information to the controller 62 such that the processor can compute the proper adjustments of the controller, servos, valves, ports, and pumps to obtain the optimal pH, coagulant doses, flocculant doses, and LSGM pressure.

As shown in FIG. 8, in a first process 201, the controller 62 sends instructions to the turbidity meter 46 to read the pH 202. Then the controller 62 reads the turbidity 204 and changes the pH 206 according to the turbidity and pH reading. In a typical optimization procedure, the wastewater pH is adjusted to reduce the turbidity of the liquid stream coming into the bloom chamber 74. This pH level is typically close to the pH at which the particles are not highly charged in order to reduce usage of treatment chemicals. The pH adjustment is typically performed by adding sodium hydroxide or sulfuric acid. Standard bench tests, which are well known to those skilled in the art, are used to establish the pH at which the minimum amounts of chemicals are needed to coagulate and flocculate the wastewater contaminants effectively. The turbidity determination step 208 analyzes the changed liquid stream. If the turbidity is lowered, the new pH is maintained 210, otherwise the liquid stream is returned to the previous pH 212.

In a second process 213, low molecular weight coagulants may be added to the wastewater sample and premixed to neutralize the charge, or slightly overcharge the particles. The controller 62 first reads the current coagulant dose 214 and the turbidity 216 as previously explained. The controller 62 then instructs the system to change the coagulant dose 218 according to prior analyzations of the liquid stream and the bench tests. Then, the system, during another turbidity determination step 220, determines whether to maintain the new coagulant dose 222 or to return to the previous coagulant dose 224. The system maintains the new coagulant dose 222 if the turbidity lowers. Alternatively, the system returns to the previous coagulant dose 224 if the turbidity rises. The controller 62 receives turbidity information from the turbidity meter 46. It is necessary to leave some charge in the liquid stream so that either flocculants of the same charge or opposite charge can be absorbed on preformed coagulate flocs that cause the growth of such flocs.

In a third process 225, the controller 62 reads the flocculant dose 228 followed by, again reading turbidity 228. The controller 62 changes the flocculant dose 230, as needed. In some cases, subsequent addition of flocculants of opposite charge relative to the coagulants yields larger, stronger flocs. For instance, the pH of motor oil and water emulsion (0.2% oil) can be adjusted to a pH of 7. Then 50 ppm of cationic polyamine coagulant is added to nearly neutralize the charge. Then 10 ppm of cationic polyacryalamide flocculant is added to slightly overcharge the pin flocs to begin flocculation. An anionic polyacryalamide (10 ppm) can subsequently be added to form large, stable flocs. Thus, the sequence of addition is pH-cationic coagulant-cationic flocculant-ionic flocculant. The bench test analysis is used to determine the optimal amount of charge satisfaction chemistry so as to optimize the removal of the contaminants from the liquid stream, while utilizing minimal expensive chemicals. If the turbidity is lowered by the change in flocculant dose 230, the system maintains the new flocculant dose 234. Otherwise, the system simply returns to the previous flocculant dose 236. Adding excessive chemicals can actually reduce the effectiveness of the system.

In a fourth process 237 embodied in FIG. 8, the controller 62 reads the LSGM pressure 238 via the turbidity meter 46. Again, the controller 62 reads the turbidity 240 and thereafter changes the LSGM pressure 242. During a turbidity determination step 244, the system will maintain the new LSGM pressure 246 if the turbidity is lowered; otherwise the system will return to the previous LSGM pressure 248 if the turbidity rises. Pressure within the system may be changed by the pump 68, the flow control valve 75, or the pressure gauge 76, as previously described. Increasing or decreasing the pressure within the system can have a direct affect on the mixing speed. Completion of the fourth process signals an end 250 of the process of FIG. 8. The controller 62 is further programmed with the information received during the process embodied in FIG. 8 and adjusts the variables within the wastewater treatment control system 10 accordingly.

The control system 10 is set up to administer each of the chemical constituents with a mixing time and mixing energy optimized by the processes described above. The process analyses each chemical component introduced into the wastewater stream. The process embodied in FIG. 8, and as previously discussed above, fine-tunes the proper combination of mixing time, mixing energy, and chemical additives to achieve the lowest possible turbidity. Moreover, the addition of a gas source and a gas control loop on one or more of each of the mixers 12 permits the simultaneous entrainment of dissolved gas. This entrained gas is used for the formation of nucleation sites where bubbles will later form inside the structure of a floc. Using the controller 62 to optimize the step ensures maximized performance with minimal chemical cost. Most all DAFs deliver pre-formed bubbles to pre-formed flocs. These bubbles are mostly too large to form attachments to the flocs. The attachments that form are made on the outside of the floc structures and are easily dislodgeable. The attachments in accordance with the present invention are formed within the floc structure and become physically incorporated into the floc filaments when attached to one another. The gases (nanobubbles) entrapped inside the evolving flocs provide sites where dissolved gas eventually deposits as the pressure of the mixing system is decreased. Large buoyant bubbles form, which carry the flocs to the surface of the water of the flotation tank 16. The bubbles mechanically displace a great deal of water from the surface of the flocs making the floc even more buoyant.

Although several embodiments have been described in detail for purposes of illustration, various modifications may be made to each without departing from the scope and spirit of the invention. Accordingly, the invention is not to be limited, except as by the appended claims.

What is claimed is:

1. A process for treating wastewater, comprising the steps of:
adding a chemical to a wastewater treatment input fluid;
vigorously mixing the chemical and the fluid within a chamber;
measuring turbidity of the fluid exiting the chamber; and
adjusting the amount of chemical added, mixing duration or mixing energy applied to the fluid to lower the turbidity of the fluid.

2. The process of claim 1, further comprising the step of performing a bench test on the fluid to determine the chemicals to be added to the fluid at rates that minimize the turbidity.

3. The process of claim 1, wherein the mixing step includes the step of injecting the fluid and the chemical into the chamber to form a spinning vortex.

4. The process of claim 3, including the step of injecting a gas into the chamber to form an evacuated area within the vortex and increase the mixing energy.

5. The process of claim 4, including the step of visually, sonically or electronically monitoring the length of the evacuated area.

6. The process of claim 1, wherein the adjusting step includes the step of adjusting injection of fluid into the chamber.

7. The process of claim 6, wherein the injection adjusting step includes the step of rotating a sleeve relative to the chamber.

8. The process of claim 1, including the step of regulating chemical flow rate by means of a pump.

9. The process of claim 1, wherein the adjusting step includes the step of utilizing a plurality of mixing chambers.

10. The process of claim 9, wherein the utilizing step includes the step of managing the liquid flow rate by means of a controller.

11. The process of claim 10, including the step of programming each chamber to receive a distinct combination of chemicals, mixing time, and mixing energy.

12. The process of claim 1, including the step of pressurizing the wastewater treatment fluid within a plenum disposed between the chamber and a reactor head.

13. The process of claim 1, including the steps of adjusting the fluid temperature, pH, flocculant quantity, or coagulant quantity.

14. The process of claim 13, including the step of rereading the turbidity and making further adjustments to chemical amounts added, mixing duration or mixing energy applied to the fluid.

15. The process of claim 14, including the step of maintaining the adjusted fluid temperature, pH, flocculant quantity, or coagulant quantity when the desired turbidity is achieved.

16. The process of claim 1, including the step of measuring the turbidity in real-time and using such measurements to periodically adjust the chemical quantity, mixing energy or mixing time to achieve the desired fluid turbidity.

17. The process of claim 1, including the step of bubbling the fluid through a cavitation plate located within a nucleation chamber in fluid communication with a flotation tank, whereby bubbling flocculates waste within the liquid.

18. The process of claim 17, wherein the bubbling step further includes the step of removing a froth formed on the surface of the flotation tank.

19. The process of claim 18, further including the step of dewatering the froth by means of a removal tank.

20. A process for treating wastewater, comprising the steps of:
adding a chemical to a wastewater treatment input fluid;
vigorously mixing the chemical and the fluid within a chamber;
measuring real-time turbidity of the fluid exiting the chamber;
periodically adjusting the amount of chemical quantity, mixing duration or mixing energy applied to the fluid in view of the turbidity measurements;
rereading the turbidity; and
readjusting the chemical amounts added, mixing duration or mixing energy applied to the fluid.

21. The process of claim 20, including the steps of adjusting the fluid temperature, pH, flocculant quantity, or coagulant quantity.

22. The process of claim 21, including the step of maintaining the adjusted fluid temperature, pH, flocculant quantity, or coagulant quantity when the desired turbidity is achieved.

23. The process of claim 20, including the steps of:
bubbling the fluid through a cavitation plate located within a nucleation chamber in fluid communication with a flotation tank;
flocculating waste within the liquid; and
removing a resulting froth formed on the surface of the flotation tank.

24. The process of claim 23, further including the step of dewatering the froth by means of a removal tank.

25. The process of claim 20, wherein the mixing step includes the step of injecting the fluid, the chemical, and a gas into the chamber to form a spinning vortex having an evacuated area within, to increase mixing energy.

26. The process of claim 25, including the step of visually, sonically or electronically monitoring the length of the evacuated area.

27. The process of claim 20, wherein the adjusting step includes the step of adjusting injection of the fluid into the chamber by rotating a sleeve relative to the chamber.

28. The process of claim 20, including the step of regulating chemical flow rate by means of a pump.

29. The process of claim 20, wherein the adjusting step includes the step of utilizing a plurality of mixing chambers.

30. The process of claim 29, including the step of programming each chamber to receive a distinct combination of chemicals, mixing time, and mixing energy.

31. The process of claim 30, wherein the programming step includes the step of managing the liquid flow rate by means of a controller.

32. The process of claim 20, including the step of pressurizing the wastewater treatment fluid within a plenum disposed between the chamber and a reactor head.

33. The process of claim 20, further comprising the step of performing a bench test on the fluid to determine the chemicals to be added to the fluid at rates that minimize the turbidity.

34. A control system for treating wastewater, comprising:
a mixer for blending an additive with wastewater;
a flotation tank fluidly coupled to the mixer;
a meter disposed in the flotation tank for measuring turbidity of the wastewater; and
a controller electrically coupled to the mixer and the meter, wherein the controller determines the additive quantity, mixing time and mixing energy applied to the wastewater to achieve the desired turbidity.

35. The control system of claim 34, including a pump for managing wastewater flow rate entering the mixer.

36. The control system of claim 34, wherein the mixer includes a port formed in a mixer housing.

37. The control system of claim 36, including a rotatable sleeve disposed around the exterior of the housing.

38. The control system of claim 36, wherein the port is configured such that wastewater entering the mixer forms a vortex therein.

39. The control system of claim 38, wherein the vortex includes an evacuated area.

40. The control system of claim 39, including a sensor for sonically, visually, or electrically measuring the evacuated area.

41. The control system of claim 34, wherein the meter is disposed at an exit of a nucleation chamber disposed within the flotation tank.

42. The control system of claim 41, including a cavitation plate disposed within the nucleation chamber for forming wastewater bubbles.

43. The control system of claim 42, wherein the bubbles flocculate with solid waste and float to a surface of the flotation tank to form a froth.

44. The control system of claim 43, wherein a skimmer transfers the froth to a dewatering system.

45. The control system of claim 44, wherein the dewatering system includes a holding chamber for separating the froth from water.

46. The control system of claim 34, including a plurality of mixers interconnected by a plurality of corresponding valves.

47. The control system of claim 34, including a valve disposed between the mixer and the nucleation chamber for regulating wastewater flow rate therebetween.
